(19) United States
(12) Patent Application Publication
(10) Pub. No.: US 2013/0335906 A1
(43) Pub. Date: Dec. 19, 2013

(54) SIMULATED ANODIZATION SYSTEMS AND METHODS

(71) Applicants: Michael Shamassian, Lake Forest, CA (US); peter M. On, Houston, TX (US); William Adam Graiewski, Houston, TX (US); Dustin L. Hoffman, Cypress, TX (US)

(72) Inventors: Michael Shamassian, Lake Forest, CA (US); peter M. On, Houston, TX (US); William Adam Graiewski, Houston, TX (US); Dustin L. Hoffman, Cypress, TX (US)

(21) Appl. No.: 14/001,783

(22) PCT Filed: Feb. 28, 2011
(86) PCT No.: PCT/US11/26560

§ 371 Date: Aug. 27, 2013

(51) Int. Cl. B05D 5/06; G06F 1/16

(52) U.S. Cl. CPC B05D 5/068; G06F 1/1613
USPC 361/679.08; 427/96.2; 361/679.21

(57) ABSTRACT

Simulated anodized coating systems and methods are provided. The method can include preparing an exterior surface of a metallic electronic enclosure and applying a translucent powder coating to the prepared exterior surface of the metallic electronic enclosure. The method can also include curing the translucent powder coating to form a continuous, translucent, chromatic surface on the prepared exterior surface of the metallic electronic enclosure. The method can also include applying a transparent, matte, liquid coating over the cured translucent powder coating to provide a consistent matte, continuous, chromatic surface on the prepared exterior surface of the metallic electronic enclosure.

### BACKGROUND OF THE INVENTION

### Description of the Related Art

Anodization is an electrochemical process whereby a metallic, usually aluminum, object is colored with a translucent dye. Far from being just a surface coating, anodization requires the supply of an electrical current to the metal object while the object is suspended within an electrolytic dye solution. The current applied to the object tends to draw the electrolytic dye into the pores present on the surface of the metal thereby providing a durable coating that is more than just “skin deep.” The anodization process requires the use of potentially hazardous dye solutions and, due to the nature of the electrolytic process, surface flaws and color variability between batches are commonly encountered.

### BRIEF DESCRIPTION OF THE DRAWINGS

Advantages of one or more disclosed embodiments may become apparent upon reading the following detailed description and upon reference to the drawings in which:

FIG. 1 is a flow diagram depicting an embodiment of an illustrative simulated anodization method, according to one or more embodiments described herein;

FIG. 2 is a perspective drawing depicting an embodiment of an illustrative simulated anodized system, according to one or more embodiments described herein;

FIG. 2A is a partial sectional view depicting an embodiment of an illustrative anodized simulated anodized system, according to one or more embodiments described herein;

FIG. 3 is a perspective drawing depicting another embodiment of an illustrative simulated anodized apparatus, according to one or more embodiments described herein; and

FIG. 3A is a partial sectional view depicting an embodiment of an illustrative anodized simulated anodized apparatus, according to one or more embodiments described herein.

### DETAILED DESCRIPTION

Anodization provides a durable, attractive coating when applied to metallic, usually although not limited to aluminum, objects. A wide range of colors is possible dependent upon the dye or combination of dyes used within the electrolytic dye solution. Due to their inherent durability and attractiveness, anodized finishes are desirable on a wide range of consumer devices, including consumer electronic devices.

A number of variables factor in to the ultimate success of the anodization process, the variables include, but are not limited to: the substrate/metal pretreatment process, the dye mix and concentration in the electrolytic solution, the current supplied to the anodization process, and many others. Variation of one or more factors can result in color variations between each batch of parts removed from the electrolytic solution. While such variation may be acceptable on relatively low cost, commodity, items such as tube or hose fittings, such variation on a relatively high cost consumer electronic device is generally unacceptable. Color variation within anodized consumer electronic devices can reduce the acceptable yield to 70% or less—costs for unsaleable items are either borne by the manufacturer or passed on to the consumer in the form of higher retail prices for anodized items, neither provides an economically attractive solution. It would therefore be desirable to provide a simulated anodized coating suitable for use on consumer electronic devices.

A simulated anodized coating method is therefore provided. The method can include preparing an exterior surface of a metallic electronic enclosure and applying a translucent powder coating to the prepared exterior surface of the metallic electronic enclosure. The method can also include curing the translucent powder coating to form a continuous, translucent, chromatic surface on the prepared exterior surface of the metallic electronic enclosure. The method can also include applying a transparent, matte, liquid coating over the cured translucent powder coating to provide a consistent matte, continuous, chromatic surface on the prepared exterior surface of the metallic electronic enclosure.

A simulated anodized coating system is also provided. The system can include a motherboard having a central processing unit (CPU) coupled to memory and a display device. The system can also include a metallic, simulated anodized, electronic enclosure at least partially surrounding the motherboard and display device. The metallic, simulated anodized, electronic enclosure can include a cured translucent powder coating forming a continuous, translucent, chromatic surface disposed on a majority of an exterior surface forming the metallic electronic enclosure and a transparent, matte, liquid coating disposed over the baked translucent powder coating to provide a consistent matte, continuous, chromatic surface on a majority of the exterior surface forming the metallic electronic enclosure.

A simulated anodized computing system is also provided. The apparatus can include a motherboard having a central processing unit (CPU) coupled to memory, a display device coupled to the motherboard, a power cell to power the motherboard, memory, and display device and a pointing device. The apparatus can also include a two-piece, hinged, metallic, simulated anodized, electronic enclosure at least partially surrounding the motherboard and display device. The metallic, simulated anodized, electronic enclosure can include a surface preparation on all exposed exterior surfaces, the surface preparation including at least one of: brushing, chemical etching, and abrasive blasting, a cured translucent powder coating forming a continuous, translucent, chromatic surface disposed on a majority of an exterior surface forming the metallic electronic enclosure; and a transparent, matte, liquid coating disposed over the baked translucent powder coating to provide a consistent matte, continuous, chromatic surface on a majority of the exterior surface forming the metallic electronic enclosure. The apparatus can further include a keyboard input device disposed at least partially within a metallic, simulated anodized, keyboard deck. The metallic simulated anodized, keyboard deck disposed at least partially within one piece of the metallic, simulated anodized, electronic enclosure. The metallic, simulated anodized, keyboard deck can include a surface preparation on all exposed exterior surfaces, the surface preparation including at least one of: brushing, chemical etching, and abrasive blasting, a cured translucent powder coating forming a continuous, translucent, chromatic surface disposed on a majority of an exterior surface forming the keyboard deck; and a transparent, matte, liquid coating disposed over the cured translucent powder coating to provide a consistent matte, continuous, chromatic surface on a majority of the exterior surface forming the keyboard deck.

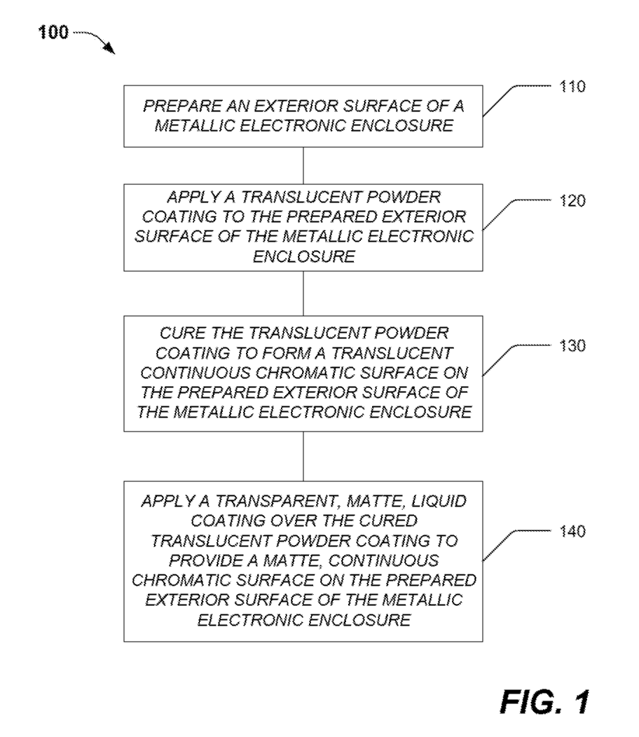

FIG. 1 is a flow diagram depicting an embodiment of an illustrative simulated anodization method 100, according to one or more embodiments. The method can include preparing an exterior surface of a metallic electronic enclosure using a suitable surface preparation system or method at 110. A translucent powder coating can be applied to the prepared exterior surface of the metallic electronic enclosure at 120. The translucent powder coating can be cured to form a translucent continuous chromatic surface on the prepared exterior surface of the metallic electronic enclosure at 130. A transparent, matte, liquid coating can be applied over the cured translucent powder coating to provide a continuous, chromatic surface on the prepared exterior surface of the metallic electronic enclosure at 140.

Preparing an exterior surface of a metallic electronic enclosure using a suitable surface preparation system or method at 110 can include any form of mechanical, chemical, or any combination of mechanical or chemical surface preparation. Preparing the exterior surface can include removal of surface contaminants such as oxidation, mill scale, dirt, and oils as well as physically preparing the surface to receive and bond with the translucent powder coating applied in 120. Surface preparation techniques can include, but are not limited to, at least one of the following: brushing the exterior surface of the metallic electronic enclosure; chemically etching the exterior surface of the metallic electronic enclosure; and abrasive blasting the exterior, surface of the metallic electronic enclosure. In some embodiments, the surface preparation can include a combination of mechanical and chemical preparation techniques, for example abrasive blasting of the exterior surface to remove oxidation, scale, dirt, and oils, followed by chemical passivation of the surface to prevent formation of oxidation prior to application of the powder coating at 120.

Applying a translucent powder coating to the prepared exterior surface of the metallic electronic enclosure at 120 can include the application of any type of electrostatically applied thermoplastic or thermoset polymer powder coating to the enclosure. Sample powder coating polymers can include, but are not limited to, polyester, polyurethane, polyester-epoxy (known as hybrids), straight epoxy (fusion bonded epoxy) and acrylics. The powder coating can have any hue or color, although to provide a simulated anodized finish, a powder coating that cures to a translucent finish can be used.

The translucent powder coating can be applied at 120 using any known or future powder coating technology, including but not limited to: electrostatic coating with a corona or similar gun-type applicator; immersion within an electrostatic fluidized bed; or electrostatic magnetic brush (“EMB”) coating. Typical cured powder coating thicknesses can range from a minimum of about 0.1 mil to about 5 mils, to a maximum of about 1 mil to about 20 mils. The final color of the cured translucent powder coating can be controlled based upon the physical properties of the powder itself (blend, color, composition, etc.) as well as the application parameters (charge voltage, bath temperature, thickness, etc.). The ability to independently control both the physical properties of the powder and the application parameters can provide a high degree of consistency from batch to batch. Batch-to-batch color consistencies in excess of 90% are possible through the use of a powder coating system; such consistency presents a considerable improvement when compared to the 70% consistency accomplished using conventional electrochemical anodization techniques.

Curing the translucent powder coating to form a translucent continuous chromatic surface on the prepared exterior surface of the metallic electronic enclosure at 130 can include thermally, optically, or chemically curing the translucent powder coating applied at 120. in some embodiments, curing the translucent powder coating can include exposing the powder to an elevated temperature, thereby allowing the powder to melt, flow out, and chemically react to form a higher molecular weight polymer in a network-like structure. In some embodiments, curing the translucent powder coating can be accomplished using a convection cure oven or an infrared cure oven.

The cured translucent powder can form a translucent continuous chromatic surface on the prepared exterior surface of the metallic electronic enclosure. The cured translucent powder can have a gloss or semi-gloss finish based upon the properties of the translucent powder used to form the coating. Since traditional anodized components frequently feature a dull, matte, finish, an additional topcoat can be applied over the cured translucent powder coating to provide a simulated anodized finish.

To provide a matte, simulated anodized finish on the prepared exterior surface of the metallic electronic enclosure, a transparent, matte, liquid coating can be applied over the cured translucent powder coating to provide a uniform, continuous, chromatic surface at 140. The application of the transparent, matte, liquid coating on top of the cured translucent powder coating provides a simulated anodized finish having a matte luster effectively simulating a true anodized finish.

In at least some embodiments the transparent, matte, liquid coating applied at 140 can include a one-part paint or coating, for example an epoxy or lacquer finish. In other embodiments, the transparent, matte, liquid coating applied at 140 can include a two part paint or coating, for example a catalyzed epoxy or lacquer finish. In some embodiments, multiple transparent matte coats can be applied to the cured translucent powder coating to improve the appearance or durability of the finish. In some embodiments, substances, such as pearlescent or metal flake pigments may be suspended within the matte liquid coating prior to its application to the cured translucent powder coating to provide special color shifting or pearlescent effects.

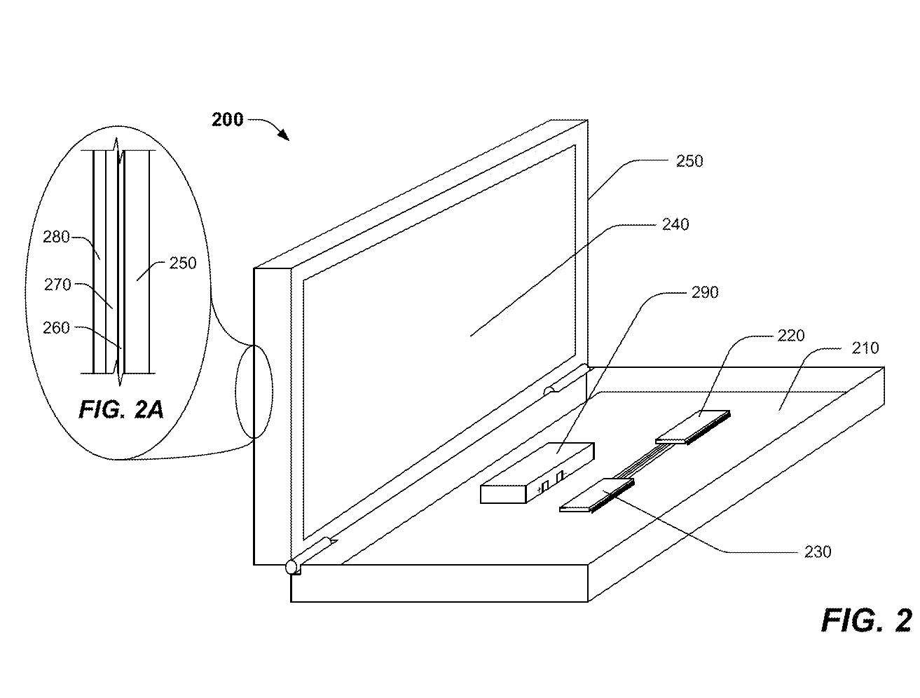

FIG. 2 is a perspective drawing depicting an embodiment of an illustrative simulated anodized system 200, according to one or more embodiments. FIG. 2A is a partial sectional view depicting an embodiment of an illustrative anodized simulated anodized system, according to one or more embodiments. The system 200 can include a central processing unit (“CPU”) 220 and coupled memory 230 disposed on a motherboard 210. A display device 240 can be coupled to the motherboard 210.

The motherboard 210, CPU 220, memory 230, and display device 240 can be at least partially disposed within a metallic, simulated anodized, electronic enclosure 250. In at least some embodiments, the electronic enclosure 250 can be a clamshell, two piece, enclosure hinged along a single axis. The exterior surface of the metallic, simulated anodized, electronic enclosure 250 can be at least partially covered with a simulated anodized finish. The simulated anodized finish can include a surface preparation 260 having a cured translucent powder coating 270 forming a continuous, translucent, chromatic surface disposed thereupon. A transparent, matte, liquid coating 280 can be disposed over the baked translucent powder coating to provide a consistent matte, continuous, chromatic surface on a majority of the exterior surface forming the metallic electronic enclosure.

The motherboard 210 can include a circuit board disposed within the electronic enclosure 250. The motherboard 210 can include the CPU 220 and the memory 230 forming a computing device. The computing device formed by the motherboard 210, CPU 220, and memory 230 can include, but is not limited to, a tablet computer, a netbook, a laptop, a portable computer, a handheld computer, a handheld gaming system, or a handheld communications device.

The display device 240 can include any data output device suitable for providing a visual display of data. Typical, non-limiting examples of display devices 240 can include liquid crystal displays (LCDs), light emitting diode (LED) displays; and organic light emitting diode (OLED) displays.

In at least some embodiments, at least a portion of the power required by the motherboard 210, the CPU 220, and the memory 230 can be provided by a power cell 290. The power cell 290 can be disposed at least partially within the electronic enclosure 250. In at least some embodiments, at least a portion of the power cell 290, for example the portion of the power cell housing forming an exterior surface of the electronic enclosure 250 can be covered with a simulated anodized coating matching the coating applied to the electronic enclosure 250. For example, referring to the illustrative embodiment depicted in FIG. 2, the bottom surface of the power cell 290 can be covered with a simulated anodized coating similar to the simulated anodized coating on the bottom exterior surface of the electronic enclosure 250.

The exterior surface of the electronic enclosure 250 can be covered partially or completely with a simulated anodized coating. An enlarged, partial, sectional view of the illustrative simulated anodized coating is provided in FIG. 2A. The exterior surface of the electronic enclosure can first be prepared by using a suitable surface preparation system or method including any form of mechanical, chemical, or any combination of mechanical or chemical surface preparation 260. By providing a prepared surface 260, the adhesion and durability of any subsequently applied coatings can be improved.

After preparing the exterior surface of the electronic enclosure, a translucent powder coating 270 can be applied to all or a portion of the prepared surfaces 260 of the electronic enclosure 250. An illustrative translucent powder coating 270 can include, for example, PPG's Duracron® coating, a thermoset, oven-cured, acrylic coating adapted to simulate an anodized finish. The translucent powder coating 270 can be applied using any known or future powder application technique, including electrostatic deposition and fluidized bed immersion. In at least some embodiments, the translucent powder coating 270 can have cured dry film thickness of from about 0.5 mil to about 5 mils.

After curing the translucent powder coating 270. the surface of the powder coating can have a gloss or semi-gloss luster which may be objectionable since most conventional anodized finishes are very low luster or matte in nature. To provide the appropriate surface sheen replicating a conventional anodized finish, a transparent, matte, liquid coating 280 can be applied over the cured translucent powder coating to provide a uniform, continuous, chromatic surface on the exterior of the electronic enclosure 250. In at least some embodiments, the transparent matte, liquid coating 280 can have a cured, dry film thickness of from about 0.1 mil to about 10 mils.

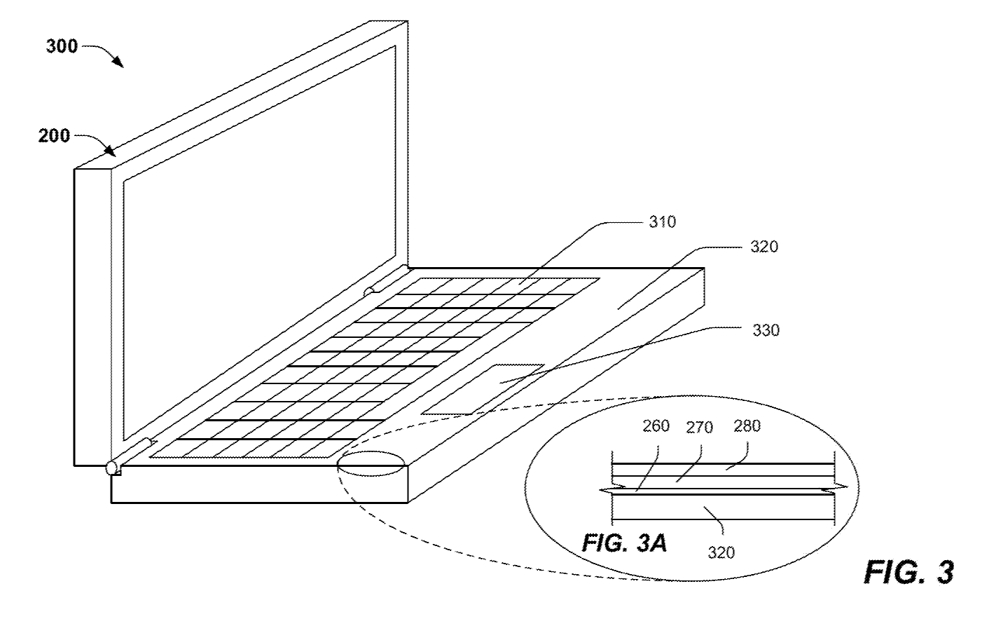

FIG. 3 is a perspective drawing depicting another embodiment of an illustrative simulated anodized system 300, according to one or more embodiments. FIG. 3A is a partial sectional view depicting an embodiment of an illustrative anodized simulated anodized system 300, according to one or more embodiments. In at least some embodiments, the electronic enclosure 250 can contain, at least in part, a data input device, a data output device, or any combination of data input and output devices. The system 300 can include a keyboard 310, keyboard deck 320, pointing device 330.

The electronic enclosure 250 can, in some embodiments, house a portable computing device such as a netbook, ultraportable, or laptop computer. In such embodiments, one or more input devices can be disposed in, on, or about the electronic enclosure 250. Typical input devices can include, for example, a keyboard 310 and pointing device 330 disposed within the keyboard deck 320.

In at least some embodiments, all or a portion of the keyboard deck 320 can include a simulated anodized coating. An enlarged, partial, sectional view of the illustrative simulated anodized coating is provided in FIG. 3A. Similar to the simulated anodized coating described in reference to the electronic enclosure 250, the keyboard deck simulated anodized coating can include surface preparation 260, a translucent powder coating 270, and a matte topcoat 280 applied over the cured translucent powder coating 270.

While the foregoing is directed to embodiments of the present invention, other and further embodiments of the invention may be devised without departing from the basic scope thereof, and the scope thereof is determined by the claims that follow.

1. A simulated anodized coating method, comprising:
preparing an exterior surface of a metallic electronic enclosure;
applying a translucent powder coating to the prepared exterior surface of the metallic electronic enclosure;
curing the translucent powder coating to form a continuous, translucent, chromatic surface on the prepared exterior surface of the metallic electronic enclosure;
applying a transparent, matte, liquid coating over the cured translucent powder coating to provide a consistent matte, continuous, chromatic surface on the prepared exterior surface of the metallic electronic enclosure.

2. The method of claim 1, the electronic enclosure to at least partially contain a computing device comprising at least one of a data input device and a data output device.

3. The method of claim 1, wherein preparing the exterior surface of a metallic electronic enclosure comprises at least one of: brushing the exterior surface of the metallic electronic enclosure; chemically etching the exterior surface of the metallic electronic enclosure; and abrasive blasting the exterior surface of the metallic electronic enclosure.

4. The method of claim 1, wherein applying a translucent powder coating to the prepared exterior surface of the metallic electronic enclosure comprises application of a translucent powder coating providing a cured powder film thickness of from about 0.1 mil to about 20 mils.

5. The method of claim 1, wherein applying a transparent, matte, liquid coating over the baked translucent powder coating to provide a consistent matte, continuous, chromatic surface on the prepared exterior surface of the metallic electronic enclosure comprises application of a liquid matte coat providing a dry film thickness of about 0.1 mil to about 10 mils.

6. A simulated anodized computing apparatus, comprising:
a motherboard including a central processing unit (CPU) coupled to memory and a display device; and
a metallic, simulated anodized, electronic enclosure at least partially surrounding the motherboard and display device;
the metallic, simulated anodized, electronic enclosure including:
a cured translucent powder coating forming a continuous, translucent, chromatic surface disposed on a majority of an exterior surface forming the metallic electronic enclosure; and
a transparent, matte, liquid coating disposed over the baked translucent powder coating to provide a consistent matte, continuous, chromatic surface on a majority of the exterior surface forming the metallic electronic enclosure.

7. The apparatus of claim 6, further comprising:
a power cell for powering the CPU, the memory, and the display device coupled to the motherboard and at least partially disposed within the metallic, simulated anodized, electronic enclosure.

8. The apparatus of claim 6, the metallic, simulated anodized, electronic enclosure comprising a clamshell electronic enclosure, hinged along a single axis.

9. The apparatus of claim 6, further comprising a keyboard input device disposed at least partially within a metallic, simulated anodized, keyboard deck;
the metallic, simulated anodized, keyboard deck disposed at least partially within the metallic, simulated anodized, electronic enclosure; and
the metallic, simulated anodized, keyboard deck including:
a cured translucent powder coating forming a continuous, translucent, chromatic surface disposed on a majority of an exterior surface forming the keyboard deck; and
a transparent, matte, liquid coating disposed over the baked translucent powder coating to provide a consistent matte, continuous, chromatic surface on a majority of the exterior surface forming the keyboard deck.

10. The apparatus of claim 9, further comprising a pointing device disposed at least partially within the keyboard deck.

11. The apparatus of claim 6, the display device comprising at least one of a liquid crystal display (LCD), an light emitting diode (LED) display, and an organic light emitting diode (OLED) display.

12. A simulated anodized computing system, comprising:
a motherboard including a central processing unit (CPU) coupled to memory;
a display device coupled to the motherboard;
a power cell to power the motherboard, memory, and display device;
a pointing device;
a two piece, hinged, metallic, simulated anodized, electronic enclosure at least partially surrounding the motherboard and display device;
the metallic, simulated anodized, electronic enclosure including:
a surface preparation on all exposed exterior surfaces, the surface preparation including at least one of: brushing, chemical etching, and abrasive blasting;
a cured translucent powder coating forming a continuous, translucent, chromatic surface disposed on a majority of an exterior surface forming the metallic electronic enclosure; and
a transparent, matte, liquid coating disposed over the baked translucent powder coating to provide a consistent matte, continuous, chromatic surface on a majority of the exterior surface forming the metallic electronic enclosure; and
a keyboard input device disposed at least partially within a metallic, simulated anodized, keyboard deck;
the metallic, simulated anodized, keyboard deck disposed at least partially within one piece of the metallic, simulated anodized, electronic enclosure; and
the metallic, simulated anodized, keyboard deck including:
a surface preparation on all exposed exterior surfaces, the surface preparation including at least one of: brushing, chemical etching, and abrasive blasting;
a cured translucent powder coating forming a continuous, translucent, chromatic surface disposed on a majority of an exterior surface forming the keyboard deck; and
a transparent, matte, liquid coating disposed over the cured translucent powder coating to provide a consistent matte, continuous, chromatic surface on a majority of the exterior surface forming the keyboard deck.

13. The system of claim 12, wherein the cured translucent powder coating on the two-piece, hinged, metallic, simulated anodized, electronic enclosure comprises a translucent, cured, powder coating having a cured film thickness of from about 0.1 mil to about 20 mils.

14. The system of claim 12, wherein the transparent, matte, liquid coating on the two-piece, hinged, metallic, simulated anodized, electronic enclosure comprises a finished coating having a dry film thickness of about 0.1 mils to about 10 mils.
